(19) United States
(12) Patent Application Publication
(10) Pub. No.: US 2014/0079859 A1
(43) Pub. Date: Mar. 20, 2014

(54) TWISTING APPARATUS

(71) Applicant: RISCO S.P.A., Thiene Vi (IT)

(72) Inventors: Giampietro RIGHELE, Thiene VI (IT); Filippo TONIELLO, Thiene VI (IT)

(73) Assignee: RISCO S.P.A., Thiene VI (IT)

(21) Appl. No.: 14/018,284

(22) Filed: Sep. 4, 2013

(30) Foreign Application Priority Data
Sep. 14, 2012 (IT) VR2012A000186

(51) Int. Cl. A23P 1/12

(52) U.S. Cl. CPC A23P 1/12
USPC 426/512; 264/310

(57) ABSTRACT

A twisting apparatus is disclosed. The twisting apparatus has a path for loading a food product extending from a loading device to a braking device. The loading device has a tubular filling body or filling cone adapted to assume at least one position in which the filling cone is in a spaced relationship or is detached from the braking device.

### CROSS REFERENCE TO RELATED APPLICATIONS

The present application claims priority to Italian patent application VR2012A000186 filed on Sep. 14, 2012, incorporated herein by reference in its entirety. The present application is related to the Italian patent application VR2012A000187 filed on Sep. 14, 2012 incorporated herein by reference in its entirety. The present application is also related to U.S. patent application Ser. No. ______ for “Twisting apparatus” filed on even date herewith, Attorney Docket Number P1284-US, also incorporated herein by reference in its entirety.

### TECHNICAL FIELD

The present disclosure relates to a sector of twisting machines or apparatus intended, for example, to twist food products with a paste-like consistency such as minced meat, an emulsified product, a cold cut product or the like. Furthermore, the present disclosure relates to a twisting apparatus of the type including a filling cone or pipe.

### BACKGROUND

In a twisting apparatus, the filling cone has a free end on which a casing is positioned, so that the food product may be filled inside the casing. After positioning of the casing, the free end of the filling cone is configured to be connected to a braking device which holds the casing and keeps it in a tensioned condition for loading or filling of the food product in order to form an encased product. At regular intervals, a twisting device causes rotation of the filling cone so as to perform a twisting of the casing (held fast by the braking device) and division of the encased food product into segments or parts.

### SUMMARY

According to some aspects of the present disclosure, a twisting apparatus includes a stationary or removable braking device and a filling cone. The filling cone is configured to assume at least one angled position in which the filling cone is in a spaced relationship or detached from the braking device. In particular, the angled position is a position angularly displaced about an axis of rotation with respect to the braking device. In such angled position, the filling cone is located on one side of, or spaced apart from, a portion of a loading path of the food product. In other words, in such angled position, the filling cone is displaced away from a zone where a loading path of the food product is present. Consequently, in order to load the casing on the filling cone, an operator may displace or position the filling cone in the angled position causing the filling cone to project on one side of the twisting apparatus without having to displace other apparatus or without having to perform operations within the volume or space of the twisting apparatus. The casing can be loaded on the filling cone away or far from the loading path of the food product.

According to some embodiments of the present disclosure, the angled position is a position which, when the apparatus is viewed in plan view or from an upper zone, the filling cone is angularly displaced laterally about an axis of rotation to one side with respect to said braking device, or said portion of the loading path. Consequently the filling cone may be displaced, for example, along a horizontal plane towards a user or an operator who is situated on one side of the twisting apparatus.

In other embodiments of the present application, the filling cone can be displaced angularly upwards or downwards with respect to the braking device. In other words, the filling cone may be displaced angularly in a vertical plane or in a diagonal plane or in an oblique plane.

According to some embodiments of the present disclosure, the filling cone can be configured to assume at least one further operative position different from said angled position in which the filling cone is connected to the braking device. The filling cone is configured to pass from an operative position for loading the product in which the filling cone is connected to the braking device to the angled position and vice versa. In this first operative position, the filling cone is coaxial with or in a position coinciding with said at least one portion of the loading path. Consequently the angled position may be reached from the first operative position and does not interfere with a step for loading or feeding the food product.

In particular, in some embodiments, the filling cone occupies a first portion of the loading path in the first operative position. The loading path also comprises at least a second portion of the loading path different from the first portion, wherein the second portion forms an angle with the first portion and is coaxial with the axis of rotation of the filling cone. The filling cone is configured to rotate about an axis coinciding with said second portion of the loading path. In other words, according to some aspects of the present disclosure, the filling cone is configured to rotate about an axis which at least partly coincides with a portion of the product loading path. Consequently, according to some aspects of the present disclosure, the loading path is at least partially sinusoidal-shaped, wherein a portion of the path is located along a first loading axis and wherein another portion of the path is located on a second loading axis, said second loading axis coinciding with an axis of rotation of the filling cone. As a result of this embodiment, it is possible to optimize the volumes and the overall dimensions of the twisting apparatus since the rotating structure of the apparatus coincides with part of the structure intended to form the loading path or channel of the food product.

According to some aspects of the present disclosure, the twisting apparatus comprises a support structure for supporting the filling cone, which is located upstream of the twisting device, such that the latter is located between the support structure and the filling cone. In the angled position, the filling cone is displaced together with said twisting device and said support structure. Consequently, in order to rotate the filling cone into the angled position, the assembly formed by the support structure and the twisting device is displaced. Furthermore, the support structure includes a pivot portion, said pivot portion being arranged to rotate in a rotational seat of a support base.

It is pointed out that in some embodiments the support structure houses at least a portion of the product loading path. More particularly, an inlet conduit for the food product is in communication with an internal cavity of the support structure and engages with the support structure coaxially with the axis of rotation. Consequently, a rotation of the assembly, formed by the support structure, the twisting device and the filling cone, does not hinder the food product feeding or loading path or results in variations of the food product loading path.

In accordance with some embodiments of the present disclosure, the loading device includes a passage duct placed in fluid communication between the filling cone and the support structure. When the filling cone is in the first operative position, an inlet mouth of the passage duct is aligned along an axis with an inlet conduit for the food product in the twisting apparatus.

Further advantages, characteristic features and the modes of use of the subject of the present disclosure will become clear from the following detailed description of a number of preferred embodiments thereof, provided solely by way of non-limiting examples. It is clear, however, that each embodiment may have one or more of the advantages listed above; in any case it is not required that each embodiment should have simultaneously all the advantages listed.

### BRIEF DESCRIPTION OF DRAWINGS

Reference shall be made to the figures in the accompanying drawings in which:

FIG. 1 shows a view from above or plan view of a twisting apparatus according to an embodiment of the present disclosure;

FIGS. 2-4 show views from above of a twisting apparatus according to an embodiment of the present disclosure in respective operative positions;

FIG. 5 shows an axonometric view of a twisting apparatus according to an embodiment of the present disclosure in a first operative position;

FIG. 6 shows an axonometric view of a twisting apparatus according to an embodiment of the present disclosure in a second operative position;

FIG. 7 shows a cross-sectional view along the line VII-VII of FIG. 2;

FIG. 8 shows a cross-sectional view along the line VIII-VIII of FIG. 3.

### DETAILED DESCRIPTION

With reference to the accompanying figures, the reference number 10 denotes a twisting apparatus according to the present disclosure. In particular, the present disclosure is based on the observation by the inventor of the present patent application that, in order to load the casing onto the free end of the filling cone, the twisting systems proposed hitherto include a movable braking device, namely a device displaceable away from the filling cone, in order to access the free end of the filling cone during loading of the casing and that the known twisting systems involve constructional complications in order to ensure the mobility of any other processing apparatus associated with the braking device, such as belt or chain systems for conveying the product output downstream of the braking system.

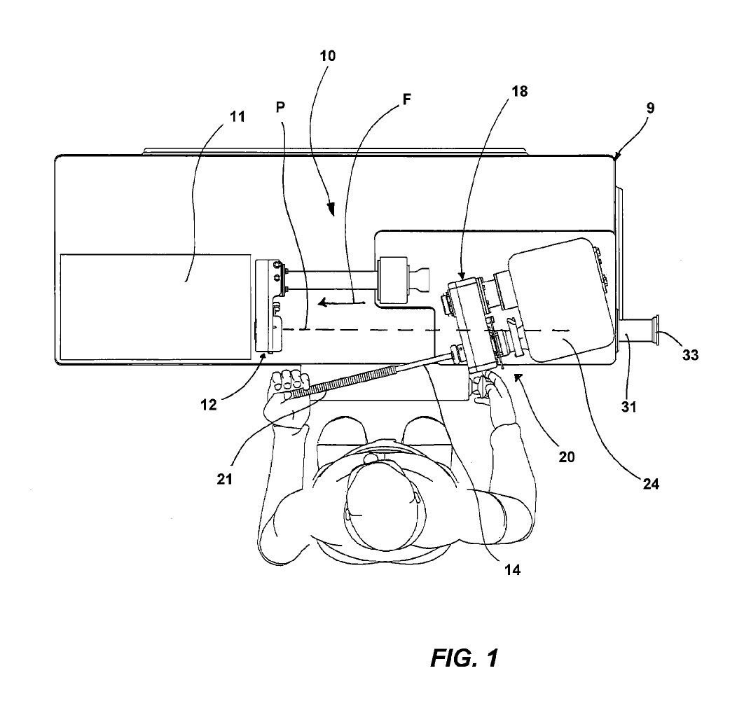

According to some embodiments of the present disclosure, and differently from the known systems, the twisting apparatus 10 can comprise a frame 9, or support structure, and a loading device 20 for a food product, mounted on the frame 9. The food product is not shown in the drawings and may be, for example, a product based on minced meat or otherwise, or a product in the form of a paste, intended to be loaded or filled inside a casing 21. The casing 21 is schematically shown in FIG. 1 in the curled-up condition.

The twisting apparatus 10 may be associated, on one side, with a filling device which feeds the product towards the twisting apparatus 10. On another side, the twisting apparatus 10 may be associated with a processing apparatus 11, where the food product is filled inside the casing 21 so as to form an “encased” food product. The processing apparatus 11 may have any form and function and does not form part of the present disclosure.

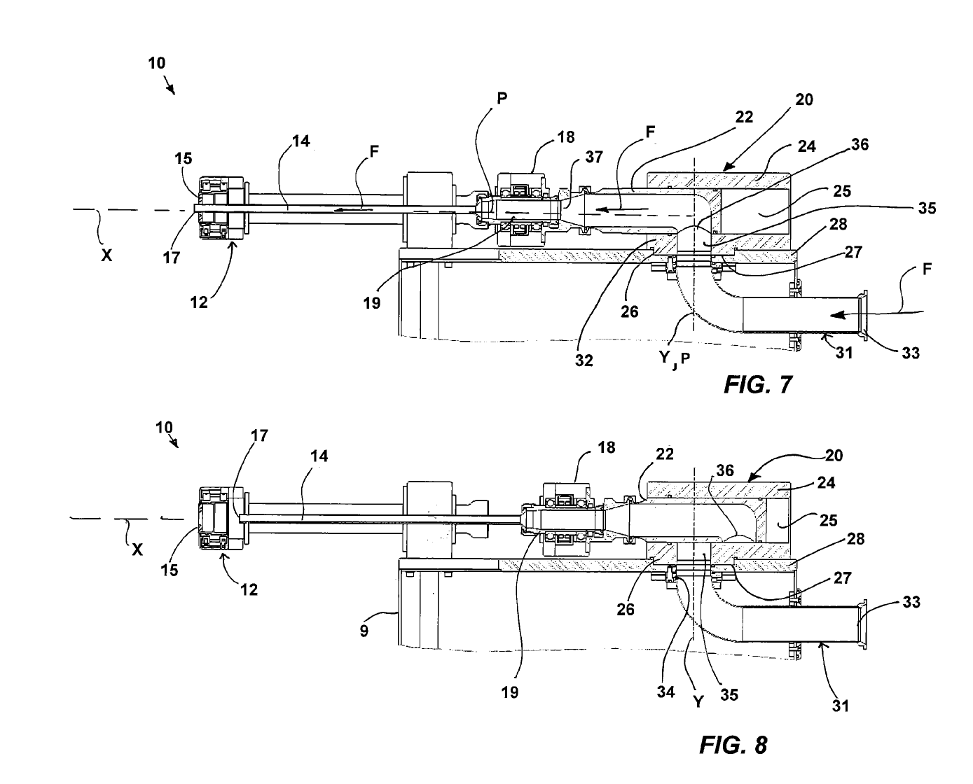

The food product, which is supplied from the filling machine and reaches the processing apparatus 11 passing through the twisting apparatus 10, defines a loading path P for the food product, which is in the direction of advancing movement of the food product. The direction of advancing movement is indicated by the arrow F in FIG. 1 (also shown in FIG. 7 discussed below). In connection with the present disclosure, each spatial reference, such as “alongside”, “on one side”, “upstream”, “downstream”, “horizontal” or “vertical”, “above” or “below”, “bottom” “retracted” or “advanced”, or similar spatial references, are to be understood as referring, by way of example, to the twisting apparatus as arranged in FIGS. 1 and 7, when in operation, and located in a base plane, where the loading path P and the direction of advancing movement of the food product may be identified.

The loading device 20 can include a filling cone or pipe 14 which, during operation, is a pipe extending along a longitudinal axis X coaxial with at least a portion of the loading path P, for filling the food product inside the casing 21.

In a normal and conventional operative condition, the longitudinal axis X can be a horizontal axis. The food product is intended to pass inside the filling pipe or cone 14.

The filling cone 14 can be mounted on a twisting device 18, which allows the filling cone 14 to rotate about its longitudinal axis X so as to perform twisting of the casing 21 when the casing 21 is mounted on a free end 17 of the filling cone 14. The twisting device 18 can be of the type known in the sector and comprises a rotating actuating member connected by means of a belt or similar movement transmission device for transmitting a transmission movement to the filling cone 14. The filling cone 14 is fixed to a tubular body 19 of the twisting device 18 which in turn is connected to the actuating member. The food product is intended to pass inside the tubular body 19.

The twisting apparatus 10 can also comprise a braking device 12 of the type known to a person skilled in the art. The braking device 12 is connected to the loading device 20 by means of a rigid arm 16. The braking device 12 is provided with a bush 15, called brake, configured to hold fast the casing 21 and produce a tension necessary for optimum filling of the product inside the casing 21. The braking device 12 is provided with an opening 13 for receiving the free end portion 17 of the filling cone 14. The connection between the loading device 20 and the braking device 12, via the rigid arm 16, is also of the type known to a person skilled in the art.

According to an aspect of the present disclosure, the filling cone 14 can be configured to assume at least one angled position in which the filling cone 14 is in a spaced relationship or detached from the braking device, said filling cone 14 in this position being angularly displaced on one side of said loading path P.

In particular, in the angled position, when the twisting apparatus 10 is viewed in plan view or from an upper zone, the filling cone 14 is angularly laterally displaced about an axis of rotation Y to one side, with respect to said braking device 12 or said loading path P.

Even more particularly, the axis of rotation Y is perpendicular to at least a portion of the product loading path P coinciding with the axis X or with the path of the food product inside the filling cone 14.

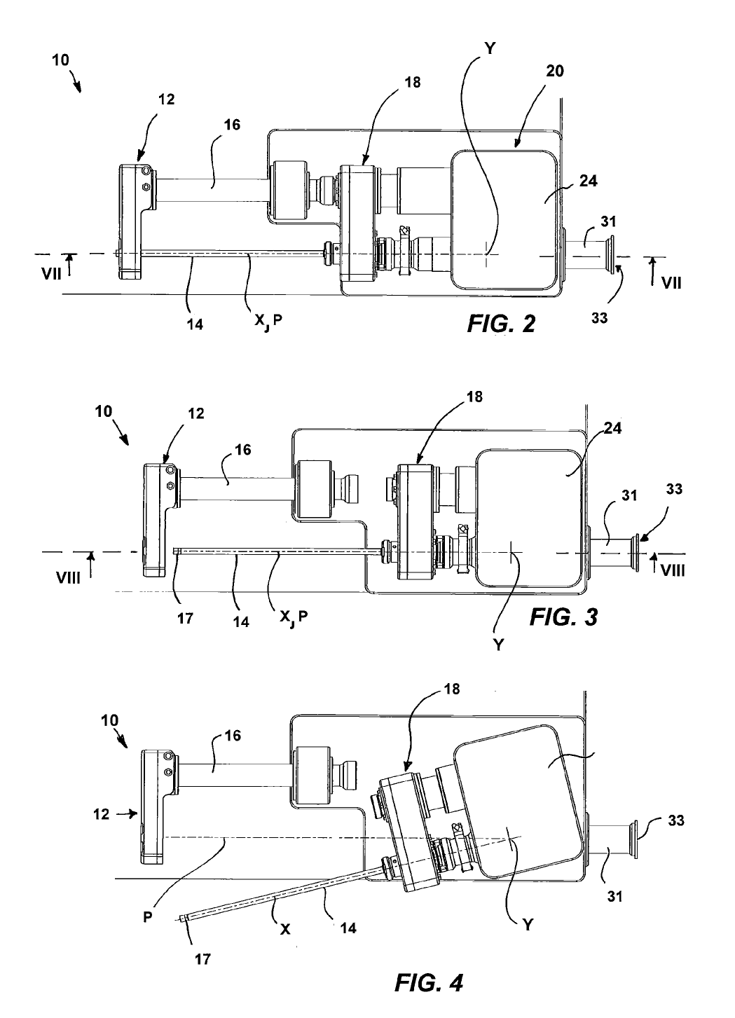

More particularly, according to aspects of the present disclosure, the filling cone 14 may assume at least three operative positions different from each other. By way of example, a first loading operative position is visible in FIG. 2, FIG. 5 and FIG. 7 and corresponds to a position in which the food product is loaded into the casing 21. In this first operative position, the filling cone 14 is arranged along a first portion of the loading path P, or along the axis X, and has a respective free end portion 17 which is housed inside the opening 13 of the braking device 12.

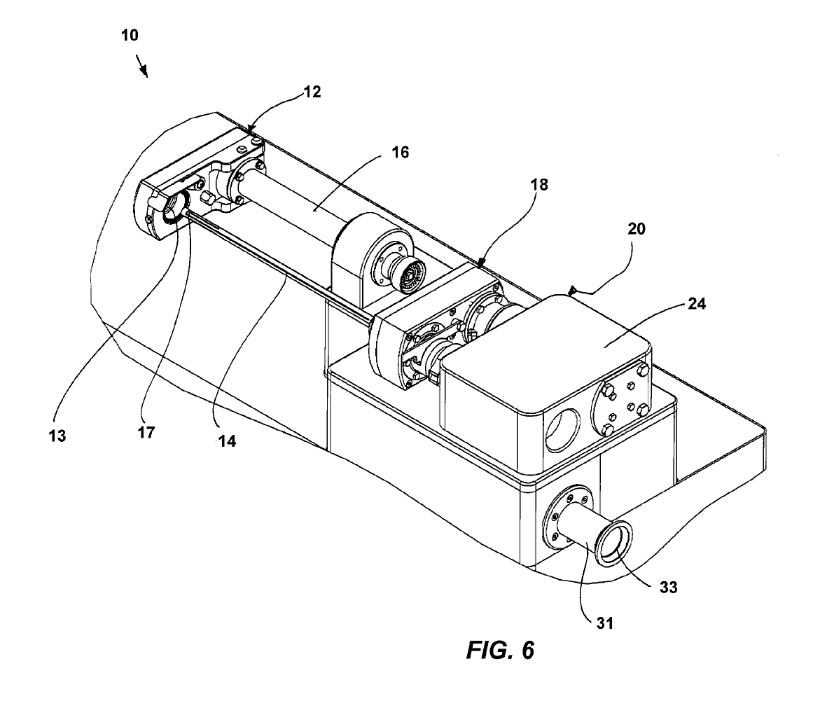

A second operative position is visible, by way of example, in FIG. 3, FIG. 6 and FIG. 8 and corresponds to a position in which the aforementioned free end section 17 of the filling cone 14 is spaced from the braking device 12. In this second operative condition, the casing 21 may be mounted on the filling cone 14, without interfering with the braking device 12. In this second operative position, the filling cone 14 has its respective free end portion 17 spaced from the opening 13 of the braking device 12. More particularly, in this second operative position, the filling cone 14 is aligned with the opening 13 of the braking device 12 in a position which is linearly retracted with respect to the first operative position, towards an upstream zone of the braking device 12.

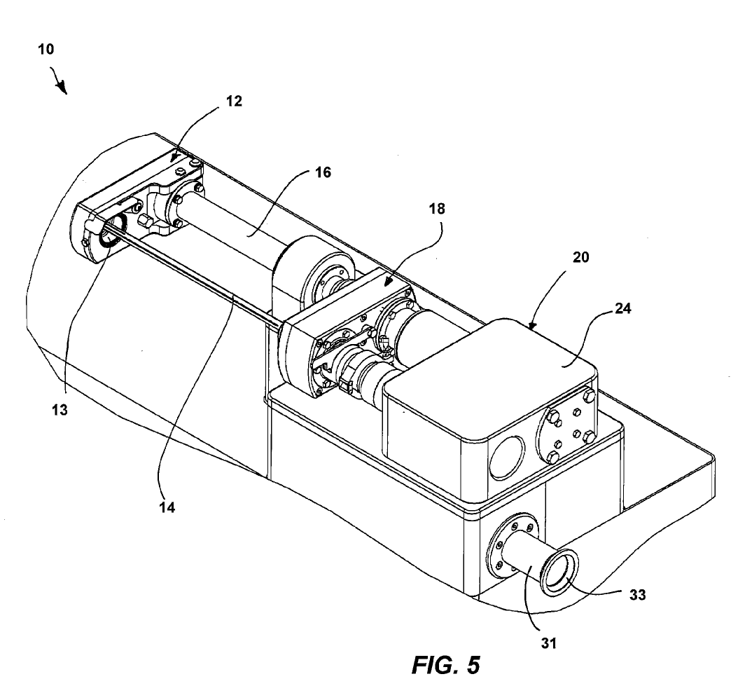

A third operative position, which is visible in FIG. 1 and FIG. 4, corresponds to the aforementioned angled position in which the filling cone 14 can be displaced laterally towards an operator, and the casing 21 may be mounted on the filling cone 14 substantially outside of the volume or general shape of the twisting apparatus 10. In this third operative position, the filling cone 14 has its respective free end portion 17 spaced from the opening 13 of the braking device 12. More particularly, in this third operative position, the filling cone 14 can be angularly displaced, or out of alignment, with respect to the opening 13 of the braking device 12, in a position which is retracted with respect to the first operative position and angularly displaced in a lateral direction, with respect to the path P. The angled position or third (laterally displaced) operative position may allow an operator to perform operations outside of the volume of the twisting apparatus 10 and not have to work within a confined spaced between the components of the twisting apparatus 10. Moreover, no displacement of the braking device 12 is required.

Moreover, according to some aspects of the present disclosure, the filling cone 14 can be displaced without performing any modifications or variations of the internal volume of the filling cone 14. In other words, the filling cone 14 can be configured to be displaced from the first position into the second position and vice versa, from the first position to the third position and vice versa, or from the second position to the third position, and vice versa, in a rigid manner, namely maintaining an internal volume which is unvaried during the passage from one position to another. Even more particularly, according to the present disclosure, the filling cone 14 is a rigid body configured to be displaced entirely without modification of its internal volume.

Consequently, in order to load the casing 21 on the filling cone 14, the filling cone 14 may be displaced in a practical manner thereby facilitating the operations for an operator. At the same time, owing to the fact that its internal volume remains unvaried, there is no leakage of food product from the filling cone 14.

According to an embodiment of the present disclosure, such as shown in the accompanying figures, the loading device 20 comprises, in addition to the twisting device 18, a passage duct 22 mounted upstream of the twisting device 18 and a case-shaped support structure 24 which is configured to support the passage duct 22.

In particular, the passage duct 22 is fixed to the twisting device 18 and to the tubular body 19 defined above so as to allow the introduction of the product into the tubular body 19 and then into filling cone 14. The passage duct 22 is connected to the twisting device 10 and to the tubular body 19 so as to be able to translate integrally and rigidly with the twisting device 18 and the tubular body 19. At the same time, the tubular body 19 is connected idle to the passage duct 22 so that a rotation about the longitudinal axis X of the tubular body 19 and the filling cone 14 is not transmitted to the passage duct 22.

According to an embodiment of the present disclosure, such as shown in the accompanying figures, the filling cone 14 can be displaced together with the twisting device 18 and the passage duct 22 with respect to the support structure and with respect to the frame 9 from the first position into the second position and vice versa. Furthermore, the support structure 24 comprises an internal cavity 25, which is configured to receive the passage duct 22 when the filling cone 14 is in the second operative position. This configuration allows displacement of the filling cone 14 from the first operative position into the second operative position in order to maintain a substantially constant (or in some cases smaller) volume of the entire twisting apparatus 10. In fact, the passage duct 22, in the second operative position, occupies a free zone (cavity 25) inside the support structure 24 so as not to occupy additional spaces and allow the entire twisting apparatus 10 to be kept within the maximum dimensions.

According to an embodiment of the present disclosure, such as shown in the accompanying figures, the filling cone 14 can be displaced together with the twisting device 18 and the passage duct 22 and the support structure 24 from the second position to the third position and vice versa, namely can be displaced from a position aligned with the braking device 12 into a position angularly displaced with respect to the braking device 12. Even more particularly, for this purpose, the support structure 24 has a pivot portion 26 projecting downwards from a bottom wall 32 which is arranged rotatably in a rotational seat 27 of a support base 28 of the frame 9. In other words, the support structure 24 is mounted rotatably about the axis Y. Rotation of the support structure 24 about axis Y causes, as mentioned above, angular displacement of the filling cone 14, the twisting device 18 and the passage duct 22 from the second position into the third position. Such an angular displacement is visible in FIG. 4. It can be seen that in the third operative position the assembly formed by the filling cone 14, twisting device 18 and passage duct 22 allows the entire twisting apparatus 10 to maintain a substantially constant volume and moreover does not require disassembly of any component of the twisting apparatus 10 with respect to the frame 9.

Consequently, the passage duct 22 is translatable integrally with the filling cone 14 and with the entire twisting apparatus, in a linear and retractable manner, inside a cavity 25 of the support structure 24. This linear displacement or translation allows freeing of the end 17 of the filling cone 14 which is inserted inside the opening 13 of the braking device 12 and allows easy loading of the casing on said end 17 by an operator.

In particular, the filling cone 14 together with the passage duct 22 is displaced inside the cavity 25 of the support structure 24. In the embodiment shown, the passage duct 22 is a tubular body and also the cavity 25 is substantially tubular.

According to an embodiment of the present disclosure, such as shown in the accompanying figures, the twisting apparatus 10 comprises an inlet conduit 31 for introduction of the food product, said inlet conduit 31 being one piece or a component separate or detached from the passage duct 22. In particular, according to this embodiment, the inlet conduit 31 engages from below with respect to the support structure 24 so that product may be introduced from below into the passage duct 22.

In particular, the inlet conduit 31 is positioned below the base 28 and is in communication with the cavity 25 of the support structure 24. Furthermore, the inlet conduit 31 engages with the support structure 24 along an axis (loading axis) which coincides, as will be described more fully below, with the aforementioned axis of rotation Y. In this connection it is pointed out that the bottom wall 32 of the support structure 24 has an opening 35 for placing the passage duct 22 in communication with the inlet conduit 31.

According to an embodiment of the present disclosure, such as shown in the accompanying figures, the inlet conduit 31 is elbow-shaped with an inlet mouth 33 having a substantially horizontal axis and an outlet mouth 34 having a substantially vertical axis. The passage duct 22 is also elbow-shaped with an inlet mouth 36 having a substantially vertical axis and outlet mouth 37 having a substantially horizontal axis.

The inlet mouth 36 of the passage duct 22 and the outlet mouth 34 of the inlet conduit 31 are located in alignment with each other and so as to communicate with each other, via the aforementioned opening 35, when the filling cone 14 is located in at least one operative position, for example, when the filling cone 14 is located in the first operative position.

Consequently, as can be seen from the drawings, in an embodiment such as that shown in the figures, the inlet conduit 31 and the passage duct 22, when connected together, define a channel for the passage of the food product from the filling machine to the processing apparatus 11, where the channel for the passage of the food product from the filling machine is at least partially sinusoidal-shaped.

Owing to the introduction of the food product into the passage duct 22 from below, it is possible to obtain a twisting apparatus 10 in which the food product is introduced from below. This position of the inlet mouth 33 is fully compatible for connection with a filling machine.

According to a further aspect of the present disclosure, which can be seen for example in the embodiment shown in the figures, the inlet conduit 31 and the passage duct 22 have a respective vertical portion which is aligned along an axis with the loading axis Y, namely the vertical axis of rotation or pivot axis described above. As seen from FIGS. 7 and 8, the inlet conduit 31 and the passage duct 22 have a respective vertical portion which is coaxial with the pivot portion 26 of the support structure 24. Consequently, the support structure 24 is rotated from the second operative position into the third operative position, by rotating about the same loading axis Y along which the food product is introduced from below.

It should be noted that the axes coincide at different times. In fact, the axis of rotation is configured to coincide with said portion of the loading path P, when no food product is passing through, namely in a condition of absence of passing food product. In other words, according to some aspects of the present disclosure, the loading path P envisages at least one first portion, coinciding with the axis X of the filling cone 14, namely coinciding with the first operative position of the filling cone 14, and at least one second portion, different from the first portion, where the second portion forms an angle with the first portion and is coaxial with the axis of rotation Y. Consequently the filling cone 14 is configured to rotate about an axis coinciding with at least one portion (e.g. the second portion) of the loading path P.

Such configuration allows further compaction of the parts and limitation of the spaces and volumes of the twisting apparatus 10 as a whole. In fact, a rotation about the loading axis allows displacement of a limited number of parts or components for lateral displacement of the filling cone 14, by making use of the components or parts of the apparatus intended to form a loading path for the product. Moreover, as a result of this configuration, it is possible to obtain a twisting apparatus which is very compact, despite being able to assume a plurality of operative positions. Consequently, it is possible to rotate the entire loading device 20, including the twisting device 18, about the axis Y, namely about the loading axis or axis of engagement of the inlet conduit 31 inside the cavity 25 of the support structure 24. As mentioned above, the possibility of rotating the entire loading device 20 about the axis Y offers the advantage of being able to displace laterally the filling cone 14, for example, towards an operator, and also facilitating positioning of the casing on the filling cone 14, this manoeuvre being performed by means of a simple lateral rotation, with a reduced volume and reduced displacement of parts, while ensuring a high degree of compactness of the twisting apparatus 10.

A mode of operation of the twisting apparatus 10 may be described below. Initially, in order to load a casing on the free end 17 of the filling cone 14 (where in this condition the filling cone is set to the pause condition), the filling cone 14 and the passage duct 22 are displaced linearly inside the support structure 24. Owing to the layout of the parts described above, the inlet mouth 36 of the passage duct 22 is not aligned with the axis of rotation Y, and the passage duct 22 closes the opening 35 of the support structure 24, without causing variations in the internal volume of the entire path of the food product.

Thereafter, the entire loading device 20 is angularly rotated about the axis of rotation Y so as to move the filling cone 14 into the vicinity of the operator who is situated on one side of the twisting system 10. The free end 17 can be accessed by the operator in order to perform the operations for insertion of the casing 21, and at the same time, the operator may operate the filling cone 14 without placing his/her hands directly inside the twisting apparatus 10. After loading the casing 21, the entire loading device 20 is positioned again in its original position (first operative position) with the filling cone 14 aligned and inserted inside the respective opening 13 of the braking device 12. The braking device 12 stably retains the casing 21 on the filling cone 14 so as to ensure the necessary tension for optimum filling of the casing.

Then the filling device is started and the food product is introduced via the inlet conduit 31 so as to be introduced through the filling cone 14 into the casing 21. At periodic intervals or continuously, the twisting device 18 is activated and causes rotation of the filling cone 14 so as to perform momentary twisting of the casing 21 once the required amount of food product has been filled inside the casing 21.

The examples set forth above are provided to give those of ordinary skill in the art a complete disclosure and description of how to make and use the embodiments of the disclosure, and are not intended to limit the scope of what the inventors regard as their disclosure. Modifications of the above-described modes for carrying out the disclosure may be used by persons of skill in the art, and are intended to be within the scope of the following claims. All patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the following claims.

1. A twisting apparatus comprising:
a loading device adapted to load a food product in a casing and
a braking device,
wherein a loading path of the food product extending from the loading device to the braking device is defined in said twisting apparatus, and the loading device comprises a tubular filing body or filling cone adapted to support the casing, and a twisting device adapted to rotate said filling cone,
wherein the filling cone is configured to be connected to the braking device in a first operative position for holding the casing; and the filling cone is further configured to assume at least one angled position, and
wherein in said at least one angled position said angled filling cone is angularly displaced around an axis of rotation with respect to the braking device and located on one side of at least a portion of said loading path.

2. The twisting apparatus according to claim 1, wherein the filling cone, when in said at least one angled position and when the apparatus is viewed in a plan view or from an upper zone, is angularly displaced around said axis of rotation to one side with respect to said braking device or with respect to said at least the portion of the loading path.

3. The twisting apparatus according to claim 2, wherein the loading path comprises at least a first portion of the loading path and at least a second portion of the loading path different from the first portion of the loading path, wherein the filling cone occupies said first portion of the loading path in said first operative position, and wherein the second portion of the loading path defines an angle with the first portion of the loading path and is coaxial with the axis of rotation, such that the filling cone is configured to rotate about an axis coinciding with said second portion of the loading path.

4. The twisting apparatus according to claim 3, wherein said axis of rotation is arranged to coincide with said second portion of the loading path in different operational time periods and/or at least in conditions corresponding to absence of the food product.

5. The twisting apparatus according to claim 3, wherein said filling cone is further configured to assume a second operative position, wherein said filling cone is in a linearly retracted position with respect to the braking device, said second operative position being intermediate between said first operative position and said at least one angled position.

6. The twisting apparatus according to claim 1, wherein the loading device comprises a support structure for supporting the filling cone, wherein the twisting device is located between the support structure and the filling cone, and wherein, the filling cone, in said at least one angled position, is displaced together with said twisting device and said support structure.

7. The twisting apparatus according to claim 6, wherein the support structure comprises a pivot portion, said pivot portion being arranged to rotate about the axis of rotation in a rotational seat of a support base.

8. The twisting apparatus according to claim 7, further comprising an inlet conduit in communication with an internal cavity of the support structure, the inlet conduit engaging with the support structure coaxially with the axis of rotation.

9. The twisting apparatus according to claim 8, wherein the inlet conduit engages in a lower zone or from below with respect to the support structure.

10. The twisting apparatus according to claim 9, wherein the inlet conduit is elbow-shaped comprising an inlet mouth arranged on a horizontal axis and an output mouth arranged on a vertical axis, said output mouth being configured to be placed in communication with the filling cone.

11. The twisting apparatus according to claim 10, wherein the loading device comprises a passage duct placed in fluid communication between the filling cone and the support structure, wherein, an inlet mouth of the passage duct is aligned along an axis with the output mouth of the inlet conduit and said output mouth axis coincides with the axis of rotation, when the filling cone is in the first position.

12. The twisting apparatus according to claim 1, wherein said loading path is at least partially sinusoidal-shaped, wherein a portion of the loading path is located along a first loading axis and wherein another portion of the loading path is located on a second loading axis, said second loading axis coinciding with the axis of rotation of the filling cone.

13. A twisting apparatus comprising:
a loading device adapted to load a food product in a casing and comprising a tubular filing body or filling cone adapted to support the casing;
a braking device; and
a twisting device adapted to rotate said filling cone,
wherein the loading device and the braking device defining a loading path of the food product from the loading device to the braking device, and
wherein the filling cone is configured to be moved from a first operative position to at least one angled position, wherein in the first operative position the filling cone is connected with the braking device for holding the casing and in said at least one angled position, said angled filling cone is spaced apart from the braking device and disconnected from the braking device.

14. The twisting apparatus according to claim 13, wherein the filling cone, in said at least one angled position and when the apparatus is viewed according to a plan view or from an upper zone, is angularly displaced around an axis of rotation to one side, with respect to said braking device, or with respect to a portion of the loading path.

15. The twisting apparatus according to claim 14, wherein said filling cone is configured to assume a second operative position, said second operative position of said filling cone being in a linearly retracted position with respect to the braking device and being timely intermediate between said first operative position and said at least one angled position.

16. The twisting apparatus according to claim 15, wherein the loading device further comprises a support structure for supporting the filling cone, wherein the twisting device is located between the support structure and the filling cone, and wherein the filling cone, in said at least one angled position, is displaced together with said twisting device and said support structure.

17. The twisting apparatus according to claim 16, wherein the support structure comprises a pivot portion, said pivot portion being arranged to rotate about said axis of rotation in a rotational seat of a support base and wherein an inlet conduit is in communication with an internal cavity of the support structure and engages with the support structure coaxially with the axis of rotation, the inlet conduit being an elbow-shaped conduit comprising an inlet mouth arranged on a horizontal axis and an output mouth arranged on a vertical axis, said output mouth being configured to be placed in communication with the filling cone.

18. A method for twisting via a loading device adapted to load a food product in a casing, wherein the food product moves along a loading path from the loading device to a braking device designed to hold the casing, and the loading device comprises a tubular filling body or filling cone adapted to support the casing, and a twisting device intended to rotate said filling cone, the method comprising:
connecting the filling cone to the braking device, in a first operative filing step, so as to load the food product in the casing, the food product passing along a loading axis, and
displacing the filling cone with respect to the braking device, in a further operative step.

19. The method according to claim 18, wherein in the further operative step the filling cone is angularly displaced into an angled position about an axis of rotation, said angled position being angled with respect to the braking device.

20. The method according to claim 19, wherein the loading path comprises at least a first portion of the loading path and at least a second portion of the loading path different from the first portion of the loading path, the second portion of the loading path coinciding with said axis of rotation at least in a condition corresponding to an absence of food product.
